(19) United States
(12) Patent Application Publication
(10) Pub. No.: US 2025/0022221 A1
(43) Pub. Date: Jan. 16, 2025

(54) SYSTEM AND METHOD FOR FACILITATING INTERACTIONS WITH DIGITAL VIRTUAL CLONE

(71) Applicant: David Ellison, Ormond Beach, FL (US)

(72) Inventor: David Ellison, Ormond Beach, FL (US)

(21) Appl. No.: 18/765,822

(22) Filed: Jul. 8, 2024

Related U.S. Application Data
(60) Provisional application No. 63/513,233, filed on Jul. 12, 2023.

(51) Int. Cl. G06T 17/00; G06Q 30/0601; G06T 3/40; G06T 13/40; G06V 20/70

(52) U.S. Cl. CPC G06T 17/00; G06Q 30/0643; G06T 3/40; G06T 13/40; G06V 20/70

(57) ABSTRACT

A system and method for method for facilitating interactions with a digital avatar. The method includes the steps of generating artificial intelligence-based digital avatars for people wherein the digital avatars learn over time to mimic the personalities of their masters. Digital avatars can behave and express themselves like real people. The method includes establishing interactions between two digital avatars of two different people, or between a real person and a digital avatar of another person. The method allows a person to date an avatar of another person like dating a real person.

### CROSS-REFERENCE TO RELATED APPLICATIONS

This application claims priority from a U.S. provisional patent application Ser. No. 63/513,233, filed on Jul. 12, 2023, which is incorporated herein by reference in its entirety.

### FIELD OF INVENTION

The present invention relates to digital virtual clones, and more particularly, the present invention relates to a system and method for facilitating interactions with and between the digital virtual clones and real human persons and can include a method and system for product association and image delivery.

### BACKGROUND

Dating has become an important process that allows a person to find a suitable match. A lot of applications are known in the art that facilitate dating. Most of the known applications are around matchmaking and interactions. However, the known applications suffer from many drawbacks. Proposals from either person can get rejected and that may become embarrassing. The person while introducing themselves may land in an awkward situation. This is because the person willing to date the other does not know much about each other. Moreover, one person may be interested while the other may not be interested. Briefly, the dating may start with a trial-and-error process.

Moreover, people often like to talk about day-to-day life activities with friends and followers on social media platforms such as Facebook® or Twitter®. For example, people like to showcase or share their new purchases with others. However, recent studies on human social behavior suggest that social media sites tend to make people feel bad, jealous, or even insecure when others share their experiences or new acquisitions or new purchases.

Thus, a need is appreciated for improved social media and dating platforms that overcome the aforementioned drawbacks.

Hereinafter, the terms “user” and “buyer” are interchangeably used, and refer to a human, an entity, a digital avatar, and the like.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing an environment of the disclosed system, according to an exemplary embodiment of the present invention.

FIG. 2 is a block diagram showing the architecture of the disclosed system, according to an exemplary embodiment of the present invention.

FIG. 3 is a block diagram illustrating the disclosed method, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for creating a digital virtual clone of a person. The system also provides for interactions between the virtual clone and a real person. The system may also provide interaction between the digital virtual clones. Virtual clones may represent the likes, dislikes, and interests of a person. The digital virtual clones according to the present invention may resemble the personality of a person. The digital virtual clone of a person can talk and express emotions like the person while communicating with others. Moreover, digital virtual clones can understand the day-to-day life needs of a person and may act as digital assistants. The digital virtual clone can help the person in purchasing goods and services.

Disclosed are a system and method for Artificial Intelligence Lifestyles. The disclosed system and method can help a person to know another person without an actual relationship. The person, instead of approaching a real person, to express their interest, can interact with a virtual clone of that real person. This is how the disclosed system can help avoid the complexities of dating a person and getting to know each other. A person willing to date another person can avoid any embarrassment or awkwardness in expressing his interest to another person. Thus, the system allows maximizing a person's value and enabling more than one person to benefit from another in the most efficient way possible. A person willing to show an interest in dating can avoid the psychological effects of rejection, such as lowered self-esteem and insecurity. By using the disclosed system, a person can prepare by first interacting with a virtual clone of another person for dating. This may allow the first person to be more confident in showing interest as well as being in a relationship. The disclosed system provides for the need for instant gratification; loneliness checks; incompatibility checks; helping a person find a life partner (this problem goes beyond romance and is also about enhancing and improving a person's life in everyday personal and professional matters); and avoids social awkwardness (this can be amplified on social media platforms such as Facebook®, Instagram®, Twitter®, Reddit®, TikTok®, YouTube®, WhatsApp®, Snapchat®, Pinterest®, WeChat®, Quora®, Twitch®, LinkedIn®, Discord®, Tumblr®, etc. both in the real world and virtual social networks).

In society, a person's value is measured in many ways and there are no methods of measurement more focused on than a person's looks, physical appearance, and social status and compatibility. This is especially true in dating. When it comes to enabling more than one person to benefit from another in the most efficient way, duplication can be a logical solution.

When it comes to dating, particularly online dating, generally speaking, there are two individuals. The person making themselves available is the person pursued (from now on referred to as person A, with gender being irrelevant), and the person who is interested in the person who is available (person A) is the pursuer (from now on referred to as person B, with gender being irrelevant). This presents several issues and situations both for person B (pursuer) and person A (pursued). In today's world, much of the search and pursuit in dating takes place online. One such situation is where person A is not necessarily attracted to person B, but of course person B wants to date person A. Person B may approach person A to introduce themselves, however, if Person B gets rejected, he may feel rejected, hurt, and/or insecure, and might feel a lowering of their self-esteem.

Social awkwardness is also an issue for many, and the disclosed system may help them avoid said problem by enabling them to practice in a non-judgmental environment. Likewise, the system can also be used to learn the traits or characteristics or mannerisms of one person that another person might want to duplicate or follow, and in one, but not the only example, apply those duplicated traits or characteristics or mannerisms to themselves on their social media account. The disclosed system may help a user in improving or enhancing their personalities based on their role models or any person by whom they get inspired. Thus, the system may help in ways that can improve person B's ability to get more accomplished personally and/or professionally.

The disclosed system allows creating digital virtual avatars, using the features of artificial intelligence, wherein the digital avatars can mimic a variety of characteristics, traits, habits, interests, and the like of the user. This also allows the user to maximize their value in many ways. Now, person B can have what they want via person A's digital avatar, without actually approaching Person A, thus avoiding any hesitation, social rejection, and the like. At the same time, person A is saved from any awkwardness of being approached or hurting the feelings, or rejecting the proposal. Also, person A can make money or be compensated in the process (charge a fee for using person A's digital Avatar and the benefits that come with it).

In fact, the AI Avatar, can fulfill almost any of the wants or needs person B may have, from calling person B at special, or even random times (calls can be based on, but not limited to, time, location, events, etc.), to ordering items from online stores (sweetheart (person A) can I please have your (person B's) credit card?).

Person B's relationship with person A's AI Avatar may actually take over and replace some other AI-based solutions, for example, but not limited to, Apple's Siri, Amazon's Alexa, or Microsoft's Cordova, because this relationship will be based on some deeper psychological need or emotional fulfillment, would have been chosen, and not have been prepackaged.

In certain implementations, the disclosed digital Avatar can do everything that a real partner can do, emotionally or psychologically. While there will not be a physical relationship or fulfillment, person B's AI Avatar “partner” (person A's AI Avatar) can perform product ordering, phone call reminders, event scheduling, and much more. The system can connect with external servers and platforms hosting social networks, shopping, payments, and the like. The disclosed system may allow the user as well as avatars to post information and purchase items.

Besides dating, the disclosed digital avatar can help provide personalized experiences in day-to-day life. The digital avatar can act as an interface for the user to access shopping platforms, make purchases, order or booking services, and the like. The system may also allow automating parts of the process, such as payment, entering order information, and the like. In one example, the system can create a sales environment like QVC, and allow viewers and customers an option to choose what their host sounds, looks, and acts like. This host can be like the above-described digital Avatars. This will not be the only selling environment and is used as one, but not the only example.

Each customer can see the product they are ready to buy presented by their very own Avatar Presentation Model, their Avatar Presentation Model having the look, body, voice, personality, and other characteristics that are customized and much more to their liking. While the product presented will be the same and at the same time for everyone (when a QVC-like format is used), each viewer will see the product presented by a custom AI Avatar Presentation Model of their choosing. One product is represented by a customizable AI Avatar Presentation Model for every customer (because not everyone likes the same looking person and looks, and personality do sell products).

The seller will need to conform to the format for submission of the product. This format will be such that the AI Avatar Presentation Model can flawlessly present the product and so that it appears the product is actually presented by and is with the AI Avatar Presentation Model. One, but not the only tool to be used for this format, is a full 3D image of the product against a green screen background. Along with this image should be a real person presenting the same so that the app will learn how products can be presented while the full image of the product is for the AI Avatar Presentation Model to present.

In certain implementations, to maintain the anonymity of the person willing to pay for person A's AI Avatar they are interested in, there will be an option to anonymously select the person and pay, but not reveal the person who selected the AI Avatar. Everyone, but especially those preferring to be anonymous will see a warning that they should have fun and enjoy, but the disclosed platform takes safety seriously. The platform needs to let person B know that their identity while anonymous, will still be known by the platform, so no stalking, etc. There can also be different levels for the relationship between person A's AI Avatar and person B that determine a variety of boundaries or permissions, just like in a real relationship. For instance, level 1: we just met; level 2: we have been dating for a month; level 3: we are serious and living together; and so, on such that the boundaries and permissions are relative to the level.

The disclosed system may have various features and functions for real-life experiences by the digital avatar including, but are not limited to geo-location technologies, timing, voice synthesis, messaging, cellular voice calling, cameras, photo, image, and manipulation software.

Geo-location and timing feature—Person B can choose to have person A AI Avatar call them at predetermined times or places (this is especially great for maintaining organization and for socially awkward people who want to appear popular, not feel alone or lonely, etc.

In certain implementations, the disclosed system can create virtual images and videos that simulate real-life experiences. The disclosed system can receive, through cameras and computing devices, images and video feeds of persons A and B. The system can use AI functionality to create virtual images and videos of persons A and B together that may simulate them together in real life.

Besides streaming real-life-like content, the AI avatar can also discuss the images and video, perhaps about the situations, scenes, and the like in the images and videos, resembling how real persons respond to such events.

The disclosed system may also be for cellular voice calling and voice synthesis. A feature whereby person B can call person A's AI Avatar and have a full conversation just as if person B were speaking with the real person A. Likewise, person A's AI Avatar can call person B. Any call initiated by person A's AI Avatar can be based on a wide variety of criteria ranging from, but not limited to, a randomly generated call or a call based on an event to a call based on the outcome of a previous call between person B and person A's AI Avatar. A voice sampling or sample should be captured so the disclosed platform can create an accurate duplication of person A's real voice for use with person A's AI Avatar.

The disclosed system may also offer a messaging feature, whereby person B can message (SMS, MMS, etc.) person A's AI Avatar and have a full texting and multimedia conversation just as if person B were messaging with the real person A. Likewise, person A's AI Avatar can message person B. Any message initiated by person A's AI Avatar can be based on a wide variety of criteria ranging from, but not limited to, a randomly generated message or a message based on an event to a message based on the outcome of a previous message between person B and person A's AI Avatar. A message sampling or sample should be captured so the disclosed platform can create an accurate duplication of person A's real messaging style, format, etc. for use with person A's AI Avatar.

The disclosed invention can be useful in electronic platforms for selling products, such as e-commerce platforms. Sellers on the online platforms can offer their customers an option to see their (the seller's) products presented by an AI Avatar, wherein the customer can choose the AI avatar. The disclosed system and method can help increase sales enormously on e-commerce platforms.

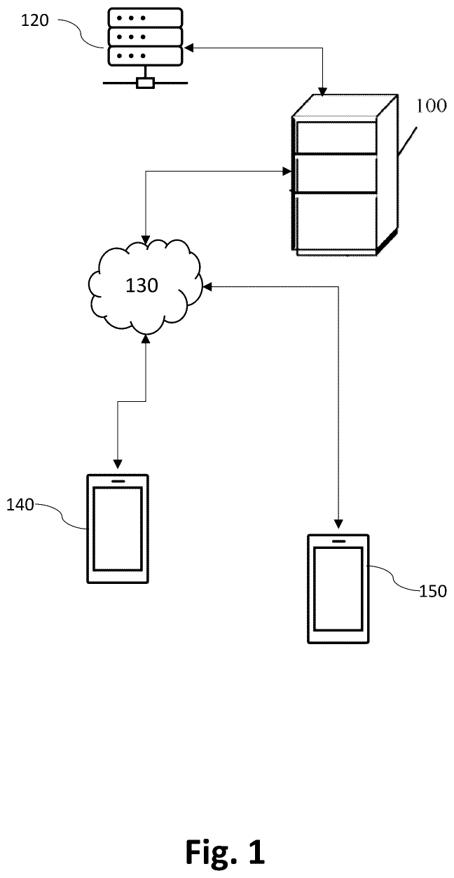

FIG. 1 shows the environment of the disclosed system 100. The system can be connected to one or more external servers 110. Examples of such servers include social media platforms, e-commerce platforms, dating platforms, and the like. The system can connect to one or more external servers through a suitable network 130. The network may be a wired network, a wireless network, or may include a combination of wired and wireless networks. For example, a local area network (LAN), a wide area network (WAN), a wireless WAN, a wireless LAN (WLAN), a cellular data network, a cellular voice network, the Internet, etc. The system can also connect to a first-user device 140 through a suitable network. The system can also connect to a second user device 150 through a suitable network. It is to be understood that the drawings show the first and second user devices, however, the system can connect to multiple user devices at the same time or at different times, and the two devices shown in the drawings are for illustration only. The user device can be a phone, a computer, a laptop, a workstation, a desktop, a projector, and the like.

The system may be implemented on one or more servers, wherein one or more servers include cloud servers. Also, one or more servers may be located at one location or geographically dispersed. It is to be understood that the embodiments, herein, may describe the disclosed methodology being performed by the system, however, one or more steps of the disclosed methodology may also be performed on external devices and/or the user device without departing from the scope of the present invention. Also, it is understood that different steps of the disclosed methodology may be performed on multiple servers without departing from the scope of the present invention. Also, is to be understood that the disclosed system may also be implemented on a user device.

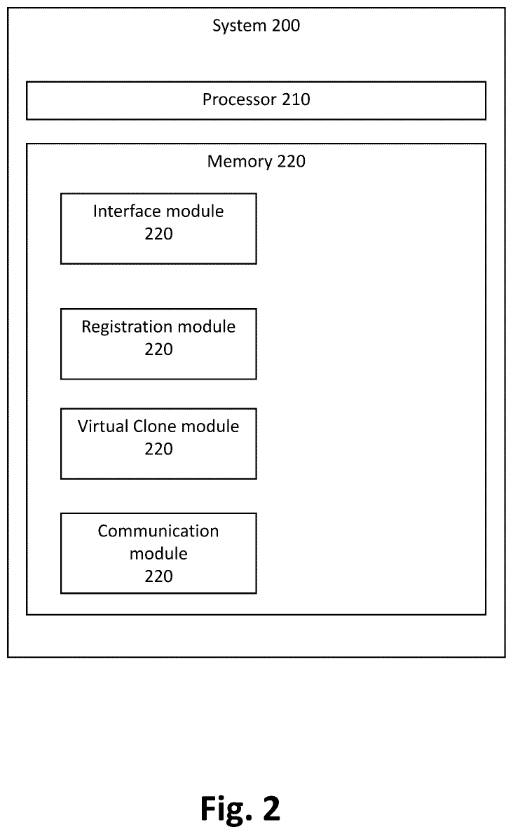

FIG. 2, which is a block diagram shows the architecture of the disclosed system 200. The disclosed system 200 can include a processor 210 and a memory 220. The processor can be any logic circuitry that responds to, and processes instructions fetched from the memory.

The memory may include one or more memory chips capable of storing data and allowing any storage location to be directly accessed by the processor. The memory includes modules according to the present invention for execution by the processor to perform one or more steps of the disclosed methodology. The memory can include an interface module 230, a registration module 240, a virtual clone module 250, and a communication module 260. The modules can be software, program, code, or a set of instructions that upon execution by the processor perform the disclosed methodology.

The interface module 230 upon execution by the processor can provide an interface that allows users to interact with the disclosed system. The interface may allow the users to both upload and download information from the system on user devices. Through the interface, a user can interact with a virtual clone of another person. The interface can be implemented as multiple screens, each screen for a specific function. The interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS.

The registration module may allow a person willing to use or interact with the disclosed system to register themselves. The system, through a suitable interface presented on the user device, can receive basic information about the user, such as name, address, contact number, and the like. These basic details can be used to create a profile of the user on the system, wherein such a profile can be stored by the system in a suitable database connected to the system. The system can then generate login details of the user, wherein the login details may allow a user to securely access the disclosed system. For example, the login details may include username and password. Password can be an alphanumeric code or token, or the like. Biometric-based login, for example, face ID, fingerprint ID, retina scan, and the like are also within the scope of the present invention.

The registration module, through a suitable interface implemented on the user device, may also obtain additional information from the user that may help create the virtual clone. The registration module may obtain permission to access and retrieve information from various social media platforms and dating platforms of which the user may be a member. The registration module can monitor and retrieve information from various platforms to learn more about the user. Also, the registration module can obtain permission from the user to access any e-commerce platform and the like. The registration module may also obtain permission from the user to access and monitor the user devices. It is to be understood that the registration module may also help the user to register themselves on any social network, dating platform, and/or e-commerce websites, and the like. Also, such permissions given by the user can be edited later as desired by the user. Using the variety of information, a user profile can be created by the registration module.

In certain implementations, the disclosed system can use two types of AI frameworks i.e., Artificial Narrow Intelligence (ANI) also known as Weak AI, and Artificial General Intelligence (AGI) also known as Strong AI. The disclosed method includes the steps of: first, Clearly defining the problem to solve and specify the objectives that the AI system needs to achieve; second, Collecting and preprocessing data for AI development; third, choosing the right tools and platforms for AI development, such as programming languages and frameworks; fourth, Developing AI models using machine learning or deep learning algorithms; fifth, Training and evaluating the AI models for accuracy and efficiency; and sixth, Deploying the AI models and integrating them with a user interface(s) or APIs. The platform may typically include:

Data: High-quality data is required to train and validate the AI models. Data can be collected from various sources, such as databases, sensors, or the Internet. Collecting high-quality data is essential for the success of the AI platform or system. Some of the best practices for collecting high-quality data include collecting data that is relevant to the problem at hand; ensuring that the data is accurate, complete, and free from errors; and collecting data from diverse sources and environments to ensure that the AI system can handle various situations.

Algorithms: Algorithms are used to develop AI models that can learn from data and make predictions or decisions. Machine learning and deep learning algorithms can be used in AI platform development.

Infrastructure: Infrastructure is required to support the development, training, and deployment of AI models. Infrastructure includes hardware, such as CPUs and GPUs, and software, such as, but not limited to, operating systems and frameworks. AI requires vast amounts of data to learn and improve its performance over time. The quality and quantity of data are crucial for the success of the disclosed AI system. AI learns from data and improves its performance over time. Some of the essential steps involved in this process are:

Data collection: The first step is to collect relevant data that can be used to train the AI system. This data could be in the form of structured data (such as data in a database) or unstructured data (such as text, images, or audio).

Data cleaning: Once the data has been collected, it needs to be cleaned to remove any noise, errors, or inconsistencies. This involves identifying and correcting errors, removing duplicates, and standardizing the format of the data.

Data preprocessing: After cleaning the data, the next step is to preprocess it to make it suitable for AI development. This could involve tasks such as feature extraction, normalization, or transformation. Some of the steps involved in data preprocessing include Feature extraction (involves selecting the relevant features from the raw data that can be used to train the AI model); Normalization (involves scaling the data to a common range to ensure that all features are weighted equally); Data augmentation (involves generating additional training data by applying transformations such as flipping, rotation, or scaling); Data labeling (if data is unstructured, it needs to be labeled to provide a correct output for the AI algorithm. This could involve image annotation or text classification); and Data splitting (it needs to be split into training, validation, and test sets. The training set is used to train the AI algorithm, the validation set is used to tune the hyperparameters of the model, and the test set is used to evaluate the performance of the model).

Algorithms: AI algorithms are used to process the data and extract insights from it for the platform. There are several types of AI algorithms, including supervised learning, unsupervised learning, and reinforcement learning.

Models: AI models are mathematical representations of the system that can make predictions or decisions based on the input data. AI models can range from simple linear models to complex neural networks. The platform is dynamic and can adapt to new situations and environments. Model selection involves choosing the right algorithm, architecture, and hyperparameters for the AI model. Some of the essential factors to consider are: type of problem (classification, regression, or clustering) plays a crucial role in selecting the appropriate algorithm); Size and complexity of data (determines the type of architecture and the number of layers in the neural network); and Hyperparameters (such as learning rate, batch size, and a number of epochs need to be tuned to optimize the performance of the model).

Some of the essential tools and platforms that need to be considered are described below:

Cloud platforms: such as AWS®, Google® Cloud, and Microsoft® Azure provide a range of services and tools that make it easier to develop, deploy, and manage the AI platform. Some of the benefits of using cloud platforms for the development of the AI platform include scalability, ease of use (pre-built AI models that can be used to jumpstart the development process), and cost-effectiveness.

Frameworks and libraries: Provide pre-built code and tools that can be used to develop AI models quickly and efficiently. Some of the popular frameworks and libraries that might be used in the development of the AI platform are: TensorFlow, PyTorch, and Scikit-learn.

Programming languages: This is a crucial part of the development of the AI platform. Some of the popular languages that might be used in AI development are Python and R (this a programming language that is widely used in data science and AI development and comes with a range of libraries and tools that make it easier to analyze and visualize data).

Training: After selecting the model, the next step is to train it using the training data.

Evaluation: Once the model has been trained, the next step is to evaluate its performance using the test data.

Deployment: The trained model needs to be deployed in a production environment, where it can be used to make predictions or decisions.

Training involves optimizing the model parameters using the training data. Some of the essential steps involved in training are the Loss function (used to measure the error between the predicted output and the actual output); the Optimization algorithm (used to update the model parameters to minimize the loss function); and Batch size and learning rate (hyperparameters that need to be tuned to optimize the performance of the model).

Evaluation involves testing the performance of the trained model using the test data. Some of the essential metrics used to evaluate the performance of the model are Accuracy (measures the percentage of correctly predicted outputs); Precision (measures the percentage of correctly predicted positive outputs out of all positive predictions); and Recall (measures the percentage of correctly predicted positive outputs out of all actual positive outputs).

Choosing appropriate algorithms and models is crucial for the success of the AI system. Some of the best practices for choosing appropriate algorithms and models are Algorithm selection (should be appropriate for the type of problem (classification, regression, or clustering)); Model selection (should be appropriate for the size and complexity of the data); and Hyperparameter tuning (should be done to optimize the performance of the model).

Regularly evaluating and refining the AI model is essential for improving its accuracy and efficiency and includes regular testing (to ensure that it is performing well on new data); continuous learning (incorporating new data into the AI model to ensure that it stays up to date); and creating a feedback loop that allows users to provide feedback on the performance of the platform.

Ensuring model interpretability is important for gaining insights into how the platform is making predictions or decisions. Some of the best practices for ensuring model interpretability include: identifying the most important features that are influencing the predictions or decisions; using visualization tools to display the results of the AI system in a way that is understandable to people (humans), and model explainability using techniques such as LIME or SHAP to provide explanations for individual predictions or decisions.

The challenges of creating the disclosed AI platform and overcoming them include: Overfitting (some ways to overcome this are: regularization techniques, early stopping, and data augmentation); Underfitting (some ways to overcome this are: increasing the model complexity, feature engineering, and hyperparameter tuning); Lack of data (some ways to overcome this are: data augmentation, transfer learning, and active learning); and Choosing the wrong model or algorithm (some of the ways to overcome this are: experimentation, research, and working with experts in the field to identify the best model or algorithm for the problem at hand).

Strategies for deploying the disclosed AI in real-world applications include: Developing APIs (Application Programming Interfaces) is a way to expose the functionality of the platform to other applications or services. Some of the benefits of developing APIs for the AI platform or system include Interoperability: APIs allow the AI platform to be integrated with other systems and services, making it more interoperable; Scalability: APIs make it easier to scale the AI system by allowing it to be used by multiple applications or services; and Flexibility: APIs provide a flexible way to interact with the platform, making it easier to customize.

Building a user interface (UI) is essential for making the AI system accessible to end-users. Some of the benefits of building a UI for the AI system include ease of use, visualization, and customization.

Integrating the system with existing systems is crucial for ensuring that it can be used effectively in real-world applications. Integrating the disclosed system with existing systems offers several benefits, such as enhancing efficiency and data-sharing capabilities. For example, the data can be easily shared between applications, collected, and analyzed. The overall process can be improved, and features of AI can be incorporated without significant investment.

Ethical considerations need to be addressed to ensure that the system is developed and used responsibly. Some of the ethical considerations are bias and fairness. The platform can be biased in its predictions or decisions, which can have adverse effects on individuals or groups. Some ways to address this include: collecting diverse data that is representative of the population to avoid biases in the data; preprocessing the data to identify and remove biases, such as gender or race bias; choosing algorithms that are less prone to biases, such as decision trees or support vector machines; and evaluating the model for biases, such as disparate impact or unfairness, using fairness metrics.

Privacy and security are essential ethical considerations when deploying the AI platform. The platform can process sensitive personal information, including, but not limited to, health records or financial data, which requires a high level of privacy and security. Some ways to address these privacy and security issues include: protecting personal data by implementing data privacy policies, such as anonymization or pseudonymization; controlling access to the AI system to prevent unauthorized access or misuse of data; encrypting data to protect it from unauthorized access or attacks; and implementing cybersecurity measures to protect the AI system from attacks or breaches.

Transparency and accountability are critical ethical considerations when deploying the platform. Some ways to address transparency and accountability issues are Model Explainability: Make the AI system explainable by using techniques such as LIME (Local Interpretable Model-agnostic Explanations) or SHAP (SHapley Additive explanations) to provide explanations for individual predictions or decisions; human oversight; and Auditing and Monitoring (ensure that it is working as intended and is compliant with ethical and legal standards).

As part of the platform, disclosed is an AI assistant that involves developing natural language processing (NLP) models that can understand and respond to user queries. Some of the essential steps to creating an AI assistant are: Gathering and preprocessing data to train the NLP models; Developing and training the NLP models using machine learning algorithms; and deploying the NLP models and integrating them with a user interface.

As part of the platform, also disclosed is an AI Avatar, or AI selfie generator which will require resources like computing power, training data, and development tools. When it comes to the architecture of the disclosed AI Avatar Generator, multiple AI frameworks and tools are available in the market. Some popular frameworks include TensorFlow and PyTorch. Choosing the right AI framework and tools is crucial.

The following are essential features:

Creating an intuitive and interactive UI is an essential element. The UI should be user-friendly and visually appealing, ensuring that users can seamlessly navigate through the processes of creating their avatars or selfies.

The target audience should be considered when creating a UI that is suitable for their needs. The UI should have clear instructions and prompts that guide users through the avatar creation process. A progress bar that shows users how far they are in the process and what steps they need to take next should be considered.

Incorporating advanced customization options that allow users to make adjustments to their selfies or avatars should be considered.

The AI Avatar Generator's algorithm takes into account features including, but not limited to color schemes, textures, and lighting to generate accurate, photo-realistic avatars. The disclosed platform can also possibly use an existing Generator.

One approach to developing the algorithm is to use machine learning techniques. The algorithm can be trained on a vast dataset of images to learn how to generate avatars that resemble real people or selfies that are an exact duplicate of real people.

A feedback mechanism that allows users to rate the generated avatars can be incorporated. This feedback can be used to improve the algorithm's performance and generate more accurate selfies or avatars. By considering the user interface, customization options, and AI algorithms, the platform AI Avatar Generator will provide users with a unique and engaging experience.

Training an AI model to generate selfies or avatars is a complex process that involves several steps. The quality of the generated selfies or avatars depends heavily on the training data provided to the machine learning model.

The first step in training an AI model is to gather high-quality images that depict different features such as eye shape, hair texture, facial structure, etc. It is important to collect images that showcase the variations of each feature as this will help the model learn to generate diverse avatars or selfies. Once the platform has gathered the images, it will prepare the data for training. This involves cleaning the data, resizing the images, and converting them to a format that the machine-learning model will understand. Labeling the data to help the model learn to differentiate between the different features might be necessary.

After gathering and preparing the training data, the next step is to select a suitable machine-learning model that fits the requirements and data size. One popular model for generating avatars is the GANs (Generative Adversarial Networks). GANs generate synthetic data that is similar to the real data used in training.

Once the AI model is selected, then configure the hyperparameters before training the model.

After configuring the AI model, the next step is to train the model on the training dataset. It is essential to monitor the model's performance during training and fine-tune it as necessary. This involves evaluating the model's results by feeding in validation datasets and making modifications to the input datasets or model structure as needed.

Disclosed are a system and method that are dynamic, intelligent, autonomous, evolving, morphing, and either complementary that makes virtually any other app better, or take on the features, functionality, and/or characteristics (in this case characteristics means, but is not limited to, look, feel and flow) of other apps (this is especially important in today's age since the evolution of software solutions happens faster than ever and equally important, such development can be performed without the need for human hours of labor, thus saving time and money). Features, functions, methods, and/or means of geo-location, such as, but not limited to, those outlined or described in a patent U.S. Pat. No. 6,912,398, assigned to David Domnitz.

The application or use of AI does not apply only to the generation of AI Avatars. The application will also use public information about a company and, along with AI, provide semi-customizable features and functionality—including, but not limited to, those in the patent U.S. Pat. No. 6,912,398, assigned to David Domnitz, to the user either every time they visit the business or integrate it permanently.

For example, a user has the platform open and visits a Smoothie King. The app will automatically know they are at a Smoothie King and, using their GPS location information and AI, look for clues, data, and information related to Smoothie King (this might or might not include Smoothie King's own app) and start creating functionality that the user will depend on during future visits. This is especially useful when a business does not have an app or the business's app lacks certain features that the disclosed application will or can provide. Scenarios like, but not limited to this one, are examples of where a person might not realize they need a solution, but could at the very least, use one.

When someone customizes the application, as the user/creator defines how the use of GPS will work to produce whatever result the user is looking for, the AI solution will show how each step of the final customized app will work and what each step will look like to the end user. This will help produce a clear vision for the user/creator creating the final custom app.

In the case where a business has an app, the app can provide complementary features or functions and create a better, seamless experience by linking to or interfacing with the app.

Additionally, can be offered a virtually limitless quantity and variety of features or functions that are specific to a type of business. These features and functions will be determined via one of several ways. Some of the ways will be by drawing a consensus via multiple user suggestions, leveraging social media or e-commerce platforms and intelligence, and/or gathering enough data that suggests such a feature or function is needed or makes sense, then the AI of, or for the app, codes for the same (features and functions) in real-time.

Another way people using the app will be able to realize AI-driven benefits will be by dragging and dropping the desktop icon of other apps into the app. Then, the app will analyze the app by comparing what the user dropped with the Google Play Store or Apple iTunes store to make sure the version the user dropped isn't a clone or infected (we will also account for any difference in revision versions between the store and the user's in case the user doesn't have the latest version, then recommend the user updates to the current version before proceeding further). Once these steps are complete, a menu will drop and instruct the user to tell the app what (the user) wants to see added to the app. Finally, the AI solution will then build the functionality or features they want.

The app will allow people to continue using other apps but within ours. For example, businesses that do not offer online ordering ability, they can easily create such an app using ours. However, for those businesses that do already offer such apps with these features, their app can run within ours.

The app is compatible and linkable or interfaceable with almost any platform. This is achieved by giving users permission via the interfacing feature of the app. This interface and process may be similar to the method and means for linking two bank accounts from two different banking institutions so that one can be controlled via the other.

Another component of the invention is Geo-related features and/or functions. These features and/or functions will be developed, refined, improved, and integrated in real-time via AI when they are not in either the app linked to, or interfaced with mine, or the stand-alone version of the app, beforehand.

Producing solutions to those instances where a person does not know what they do not know (a person thinks they have thought of everything but have not considered the things they didn't know or think of).

In certain implementations, the disclosed system and method can incorporate the following functions and features that will all be part of the same platform but will either run independently, together, or in some combination:

Stake and advertise: an option for small mobile businesses to benefit from geo-targeted advertising. Tie the small business owner's mobile device to their mobile advertising (for example: someone has a vinyl wrap ad on their vehicle, and they are carrying their cell phone. Now their cell phone is tied to their vehicle. Anyone near their vehicle (assuming the cell phone is close by too) will receive ads about the business).

Combine geo-location and asset tokenization (blockchain is included in tokenizing/tokenization).

Offer a crypto tied to each user's account.

Active locals: Individuals and groups actively displayed in real-time against the background of a virtual world or Google Street view. While the inside of a location may or may not be accurately portrayed or laid out, any corrections can be made by the owners or managers of the location by taking pics or videos of the location (as a regular video or as a 3D video) which will then be used for future reference. This will be a part of either Stake and Advertise or our Social Media Group or both. It is like an image-driven Wikipedia: an AI-driven AR/VR always on live video whose data is streamed from everyone's mobile device to determine who is where and at what time. The AI creates the look of the individuals and those people that are making money with their AI Avatar selves will have a tag that identifies them in this video. People can jump from one place to another to “put themselves into the place and visit it” by tapping on the place and choosing to visit it. The visitor then moves their mobile device around like they do when using Google Street View or the “360-degree tour” images some real estate apps and websites use to immerse themselves in the visit and give themselves a perspective of actually being there.

Buy and share instantly: (Also called PAID—Purchase with Automatic Image Delivery). A first preferred embodiment of the inventive method and system may include the following steps:

1. The user signs up for the product association and image delivery part of the platform.
2. The user provides an email address. This is the same email address that the user provided to the online store or the cashier or POS terminal at the physical store.
3. The user is given a product association and image delivery account email id, e.g., jamie@PAID.com which can be provided to the store while checking out as well.
4. The receipts are delivered to the product association and image delivery application in one or both of two ways: (a) The store sends the receipt to a common email address per retailer, e.g., macys@gmail.com, bloomingdales@hotmail.com, etc. Before the store sends the receipt to the specified email address, a web service to verify if the user's email ID exists within the product association and image delivery application; and/or (b) The store sends the receipt to the user, e.g., jamie@PAID.com, and the application catches the same and associates the receipt to a person. The user can choose to tokenize their purchase. Whether the user is a human person or an AI Avatar, the platform AI can either complete or help in the tokenization of the purchased product or service (the tokenization of assets). Since not all products, services, or purchases can be tokenized securely via the same steps or processes (for example, jewelry cannot be tokenized the same way, or via the same steps, processes, methods, means, systems, events, or requirements that would be used for real estate), the platform AI could suggest what should be included in the smart contract (and what else, if anything, is required) to ensure the best and/or most secure way to tokenize the asset(s), then even provide the pros and cons of each to the user. After choosing which methods and means for tokenization, the platform AI will generate the smart contract and utilize blockchain technology accordingly. How assets can be tokenized (to represent ownership, privileges, or rights to an asset as a tradable and on-chain token) will depend on the asset. This is due to any of a number of things, such as, but not limited to: the type of asset, the value of the asset, where the asset exists (location and if the location is fixed or portable/mobile, quantity or scarcity of the asset, normal volatility of the asset in pre-existing markets, and so on. A fringe benefit would be tracking the price or value (or changes in the price or value) of anything and locking onto that thing's pricing or value with an algorithm. This could also work with geo-location technology to help reduce or eliminate market manipulation or provide other benefits. The true value of virtually anything can be measured.
5. The receipts can come in two ways: (a) The receipts can be part of the email, or (b) The receipts come as an attachment (e.g., PNG, PDF) in the email. Receipts sent to or received via text message or social media can also be used (besides receipts received by email or the product association and image delivery app). The app can read the barcode on some receipts (that have a barcode on the receipt, and the barcode is often on the bottom) and then retrieve all the SKU, UPC, and other codes associated with the barcode at one time.
6. Upon receiving the receipt, the product association and image delivery application will (a) Convert the receipt to text format and store it in the product association and image delivery database referred to the user; (b) Read the product ID (SKU Code) from the receipt via OCR Scanning; (c) Look up the retailers' website (or database) to see if the product is available online; (d) If available online, store the Web address, Image, Description; and (e) send a notification to the user via Email, SMS, product association and image delivery mobile app; asking for permission to post on Facebook® (it is worth mentioning here that the user can also choose to use their AI Avatar in any one of several ways with their social media platform); (f) Upon getting an acceptance/time limit from the user, post on user's Facebook® wall; (g) When a user's friend clicks on the Facebook® image, the friend would be taken to a page to see the product image/description and will have a BUTTON reading “shop now” which will be injected with an affiliate code; (h) This would take the new user to the retailers' website directly; (i) System would store the time stamp, IP address, user ID with the affiliate code for a report on a monthly basis in CSV format.

The inventive application preferably includes the following components: the product association and image delivery application with its own database; the effort involved to integrate each retailer; API (application programming interface) to accept receipts per the retailer; script to convert the receipt image to text; script to look up the retailer's website or database; and fetch the product image, description, and hyperlink.

In addition to the basic app features, the following features may be included:

A picture-taking feature built into the product association and image delivery app available for the user to: (a) Take a picture of the item as usual; (b) “Tag” the image they choose to tag (for example, the picture they took, the one retrieved by the product association and image delivery app, or one the user grabs from another source, such as off the Internet or a file); (c) Take a picture of the receipt to be used in a similar manner as applications that allow the user to take a picture of a paper check for instant deposit. This feature will have OCR capability and will display to the user, what the app “thinks” is the name of the store, the address of the store, the UPC or SKU code, and the price. If the app is correct in its interpretation, then the user will click correctly. If any of the pieces of information is incorrect, the user will click accordingly and then the app will give the user the option of proceeding as is (with incorrect information to be included or excluded) or to correct the wrong piece(s) of information; (d) Change, alter, improve, or modify any image the user chooses. This feature will offer special effects (like Instagram), basic effects, editing of the components of the picture (i.e., color, contrast, etc.), inserting pictures of the user into the picture of the item, utilization of the user's AI Avatar or other permitted AI Avatar, etc. The product association and image delivery website preferably allow loading a review and pictures to the website—a sort of central location for reviews. In other words, users can upload their purchase to the product association and image delivery app, then others can share their opinions and leave reviews. This is major in building a social buzz. The key will be how people access it to pick up ideas for gifts or their next purchase. These can be categorized also. The website may be designed to be the “in” or cool place for people to drop reviews or perhaps create a star rating, and this may be used as empowerment at the social networks to build the product association and image delivery brand. This can also be used for people to price compare between online sites (e.g., Amazon, etc.). It is to be noted that while the product association and image delivery app are designed to work with existing social media platforms, features of social media platforms can also be incorporated into the system.

After the product association and image delivery app alerts the user that pictures of the images are about to be uploaded to their social media page when the user chooses to either allow or not allow the images to be uploaded, if the user chooses not to allow the images to be uploaded, the user will be asked to either don't allow all of the pictures or don't allow images of only certain products. This enables the user to edit what will be shown before it is uploaded.

When a product association and image delivery app user's friend visits the user's social media page and clicks on the picture to be taken to the user's product association and image delivery page, a price tag may appear as the mouse is moved over the picture. At the bottom of the price tag is the option to load the item into a shopping basket.

A recreation of the entire receipt in PDF form may appear on the side of each product. The option for displaying or not displaying specific pieces of information from the receipt (such as the store name, store address, prices for each product, and total purchase price) will be available to the user.

The application may also provide for creating and managing previous expenses and receipts. Receipts may be stored within a user's product association and image delivery account forever.

The inventive system provides an entirely new and separate service for any retailer. Instead of asking for a person's email address (which people give reluctantly if at all), people will freely and more easily just provide their product association and image delivery account name or product association and image delivery address. This will be the address that retailers will ask for from now on. The product association and image delivery app will catalog our lives every day from now on by automatically capturing, storing, and organizing our purchases all the time.

To increase the value of the product association and image delivery app to some customers, the app may include a texting app (like WhatsApp®). The inclusion of the texting app will make the buying process easier for instances where shoppers need to still communicate with those they are buying for.

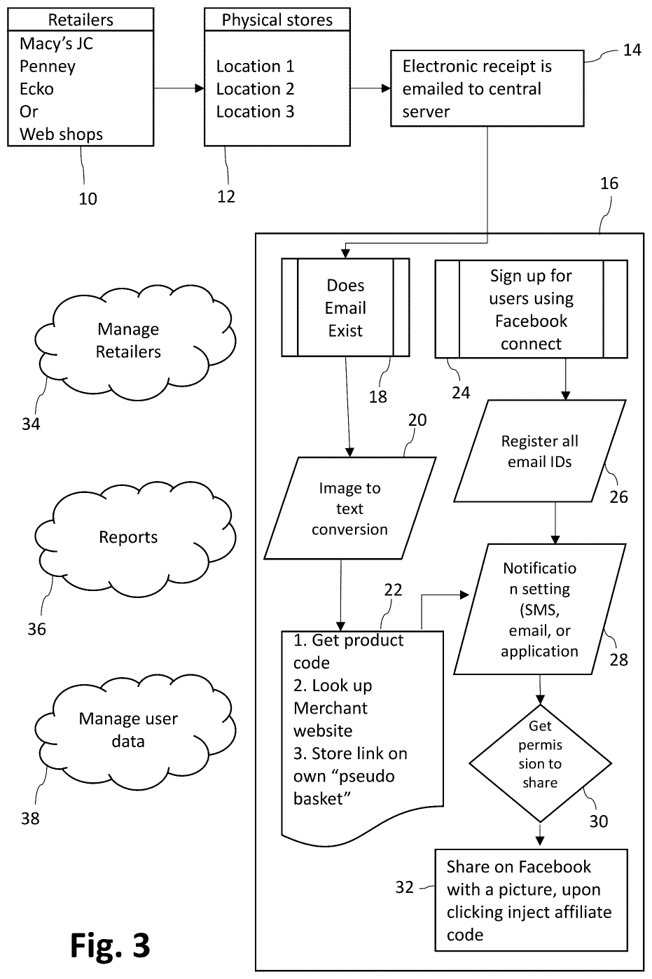

FIG. 3 is a schematic view of an alternate embodiment of the invention. A retailer user shops at retailer 10. The app determines if the store is online or a physical store 12. An electronic receipt 14 is then emailed and the product association and image delivery application server 16 determine if it is ok to use the receipt and complete the processing of the receipt information in the steps seen within the application server: Does email exist 18; Image to text conversion 20; Get product code, Look up merchant website, Store link on own “pseudo basket” 22; Sign up for users using Facebook connect 24; Register all email IDs 26; Notification setting (SMS or email or mobile app) 28; Get permission to share 30; and Share on Facebook with a picture, upon clicking inject affiliate code 32. The product association and image delivery application server are also responsible for managing retailers 34, reports 36, and managing user data 38.

The present invention can also be characterized as a system that collects receipts or payment/transactional records (preferably, but can collect any or all of the following Electronic Products Codes or RFID for example: GSI Company prefix; Global Trade Item Number (GTIN); UPC; GTIN-14; SKU; GLN; SSCC; QR Codes; Maxi Code; EAN-8; UPC-A; EAN-13; ITF 14; GSI-128; Datamatrix; Microsoft HCCB; MIT Bokode; model number; etc. directly) and can be used as a tool for sharing images of, and/or information about products or services whether the correlated payments were online or offline.

We pay for items or services and collect receipts that contain UPC, SKU, or other codes similar to the UPC or SKU, make, model, or model number data (collectively herein referred to as “coded information”) in the form of a physical record or receipt, in electronic form via email, or displayed online after successfully making a payment.

The system aggregates the coded information contained in both the physical/paper type and the electronic form. While the receipt offers a simple and already existing consolidated source for GTIN, SKU, UPC, etc., or other products, services, or location IDs, the IDs or “coded information” can be captured individually without the use of receipts. Ultimately, the invention is intended to offer a way to relate any combination of the following to each other: products; services; person; seller; lessor or lender of products or services; images; and/or location, then enable payer of products or services to share one or more pieces of this information with others through social media. Also, this system will make uniform different coded information, such as a SKU code and a model number used to refer to the same product. For example, some companies create their own code or model information for a product that has yet different coded information. This system will bridge the differences in the identification information (coded information) used for the same product. Similarly, some products might not even have a code (i.e.: UPC, SKU, or other code), but instead are referenced by make, model, or model number only. In these cases, the model or model numbers should be considered synonymous or interchangeable with, or the same as a SKU, UPC, or other code.

To collect the paper type, we need to have an application that converts the information contained in the physical record or receipt into electronic form. One way is to take a photo of the receipt and use a special program designed for image or text recognition and storage. This application is similar to software that allows people to use their cell phone to take a picture of a paper check to make a deposit or similar to receipt management software available with specialized scanners. It would be good, but not necessary, to make this part of the entire system proprietary. The cellphone camera will be one of the images and/or data-capturing tools to be used.

The emailed type is already in electronic form such as a PDF or other known format.

Images associated with the coded information should have a transparent background so only the product is in the picture. The business offering the product can provide the picture, or the user can take the picture and enter the identification information. If the option is available for a customer/user to take the picture and enter the coded information, there should be a way to let everyone know (or at least track) that the coded information was manually entered and thus subject to possible mistakes such as incorrectly entered information. This aspect of allowing the public to contribute to authoring the product image and coded information is something similar to the way Wikipedia works. An application will be available for the customer/user to take the picture without the background. The absence of the background might not be necessary but could be preferred.

The image-taking applications might be proprietary. If they are proprietary, no other image-taking application can be used for directly depositing the image to our website/program or for capturing the coded information in the physical record or receipt and converting it to electronic form and depositing it to our website/program. Two special applications will likely be created, one for capturing the image of the product and/or importing an existing image, and a second application for capturing and converting the coded information in the physical record or receipt to electronic form and/or importing an existing record or receipt of either electronic or physical origin.

Ultimately, the image, the coded information in the record, and the individual user or customer need to be related. It is known that physical transaction records or receipts usually contain more than one piece of coded information so it will be necessary to relate each of these (of which there can be, and usually is, a plurality of) contained in a single transaction record to a specific product, then to an individual image, or instead, relate the coded information directly to an image. Then, all of these become tied together for use as the user, or someone else, sees fit.

Another application should be available for a third party such as a manufacturer, wholesaler, distributor, or retailer to upload in bulk form such as in FTP (for example), the coded information and/or image of a related product or service. This source is likely the largest of what will probably be the most dependable and accurate source of data.

It might be a good idea for small thumbnail pictures (if available) to “pop up” as the user finishes manually entering the coded information contained in the user's transaction record or receipt (in whatever form it is in) as a method for checking that the coded information is correct (after all, if the coded information is entered and the user thinks they are entering a UPC or model number (for example) for a pair of jeans but instead a hammer pops up, they might want to double-check the coded information they entered).

Eventually, sellers, renters, licensors, lessors, etc. of products or services, whether retailers, wholesalers, distributors, dealers, brokers, value-added resellers, or others could just send the transaction record with the coded information, or the coded information alone to the payer's account (created within our platform) thus minimizing the number of steps needed and increasing the efficiency of delivery and speed of making the images available for use however the user or others see fit. Tokenization of assets can be completed or assisted with as well and include or exclude the platform AI.

Once the coded information is either automatically or manually referenced to a product image or picture and the user, the image of the item can be referenced and displayed with reference to (i.e., under, near, linked to, etc.) the picture of the person who paid to purchase, lease, license, etc., the product or service. Comments can then be entered in a dialogue box under the item for example.

Another foreseen added feature of the invention is that certain items such as clothing can be “modeled” by using software to fit the item on the customer/user without even having to take a picture of each item being worn. This software could be similar to the type of software used for facial recognition and will contour the image of the product over a previous real photo of the user. Likewise, the user's AI Avatar can be used in this and other scenarios or instances where a product, item, thing, service, etc. is demonstrated, modeled, presented, etc.

The feature of modeling clothing is perfect for girls who want to compare or show off their latest product or service acquisitions. This feature can also be used to help push sales of items when friends share pictures of the item.

Since an information code is associated with the item, it (the item or product related to the code) can also be easily paid for online or collected for the person to reference when they go to the store to find the same item their friend “modeled” through the program/website. The code can be used to automatically bring up a list of stores (online or offline) that carry the product.

The invention can be a simple way to sell one or more persons on a product much more easily. The invention will also allow a user to send a defined list of products with or without edited or unedited images to friends via E-mail or text in addition to social media platforms.

This is a huge advantage and a great tool since it will make showing off the product(s) quicker and easier. It might even offer a huge advantage in that a user/customer can choose the perfect picture of their self (or their AI Avatar) to “model” the product-a sort of home version of the way magazines airbrush or make models look as if they are wearing the product perfectly. In fact, to take this a step further, the user might be able to bring up a model from a magazine (the simplest way is if the image related to the products worn or advertised in the online advertisement are referenced or tagged with the same information code, but if not, that's ok too, just a little more tedious), use the program for modeling themselves in the clothing (or car as another example) and compare their self to the model in the ad. This too can be used as a sales tool.

Also, an “extra tag” can be added to the information code where the initial introduction of the product began so a complete start to finish trace of the product can be achieved.

If the coded information is recognized by two or more suppliers, meaning that both suppliers offer the same product, then there could be advantages or reasons to differentiate one supplier from the other.

A way to differentiate the suppliers should be established. An “extra tag” or appending code to add to the coded information could be a way to differentiate different locations of the same retailer (suppliers) or different suppliers of the same product (i.e., a Neiman Marcus in Orlando vs. a Neiman Marcus in Boca Raton).

Of course, the isolation of the actual coded information from the “extra tag” is essential for displaying the specific product and will not differentiate between locations. Further isolation of where the products were paid for can be done in a number of ways, including the geographic location of the payer at the time of the payment.

Other benefits realized from the invention are that it can be good for keeping track of paid items by categorizing and dating the purchase and doing so in a fun way. Another benefit is that it can be helpful for accounting and even making it easier to facilitate product returns, if need be, by accurately determining where and when a product was paid for.

There are many marketing opportunities that are both intuitively obvious now, and yet to be realized with the invention. AI will be an integral part.

The invention is a tremendous leap forward in bringing social media together with both traditional commerce and e-commerce. What is more, this is a tool that leverages social pressures and helps initiate buying of products faster yet tracks buying accurately, in real-time, and in a whole new way.

This is a powerful social media and product marketing tool.

The invention thus enables the collection, management, and association of products through means such as their identifiable codes (examples are, but are not limited to, the UPC, SKU code, model number, etc.) to an individual (preferably a person but it can be a business) whether purchased online or offline. Then the invention enables the individual to use images, pictures, or other information related to, and/or of the products for upload to any social media or communications platform for presenting the product and the individual on the web. An added benefit is that a person's location can also be determined and even tracked.

Additionally, and as an extension of or fringe benefit derived from, there is the ability to manipulate the pictures of the items and use the data gathered to enable others to pay for the same products online or offline in a faster, more efficient way. The ability to do so is almost automated.

As one example, a person can visit their friend's Facebook page, see what the friend purchased, and click on the image of the product to display a mini pop-up receipt of the product including, but not limited to, for example, UPC code, model number of product or service, and the store to purchase it.

The following is a description of an alternate embodiment of the invention as it can be used:

A user signs up and creates an account on the website. The user provides an email address that will be the designated email address they will provide retailers and other businesses if and when they choose to receive the receipt (or other type of similar record) via email. Eventually, maybe instead of an email account, retailers and other providers of products will ask for the user's account name on the website, thus eliminating the need to send the coded information to email.

The user makes a payment. They receive a transaction record or receipt in either a physical form such as paper or via email.

If the user receives a physical record of the payment such as a paper receipt for example, the user takes a picture of the receipt with our program and their cell phone camera (as one example, but not the only way, to capture the coded information. Another way is to read QR codes, barcodes, RFID tags, magnetic buttons, etc. Cell phones already offer such readers as well) and the program identifies the coded information contained within the record or receipt and stores this information on the phone (temporarily) and asks the user if the coded information is to be sent to the account associated with the phone or if it should be sent to another account. The user then chooses which. For example, and ease of description, there are sellers of products and services that group together products (for example) into a single transaction record and assign a barcode to the transaction itself, thus allowing the items to be related to the transaction barcode. Proposed is using this already existing method as one way, but not the only way, of ultimately relating a product (or products) to the person who paid.

Whether the user chooses the account associated with the phone or enters their account name, which is not associated with the phone, the code(s) are sent to their account. Pictures are referenced to the codes and might be stored in the user's account (or stored in a central database thus minimizing redundancy, storage requirements, etc. An example of such a storage source is the uniform code council) and waiting for the user to do with the pictures as they please. It is preferred that if the picture becomes modified then the modified picture is stored in the user's account exclusively.

If there is no picture automatically associated with the coded information, then the user can take a picture of the item and manually “tag” the item with the coded information (i.e.: model number, UPC, etc.) and use the picture as they wish.

If when the user makes a payment, the user chooses to receive the transaction record/receipt via email, then the user either manually cuts and pastes the record/receipt image or information within the body of the email or imports it into our program/website the record received via email as an attachment. Alternatively, this process can be automated. I envision a network exclusively for the invention. This would be used at checkout and duplicate or bypass sending the coded information to an email account.

After the information has been imported into the program/website, pictures are referenced, and the user begins uploading the pictures (manipulated or not) to their Facebook page or elsewhere. This program/website can be used with any social media and even with any other type of website where it makes sense to have this function.

The invention might work well with, or be competitive for sites such as Poshmark®, Polyvore®, or even QVC®. This might also be a good fit for Facebook® or other social networking platforms. Cryptocurrencies, the blockchains they are built on, or other technologies including, but not limited to smart contracts and/or network consensus mechanisms, could be extremely useful for determining buying patterns; relationships; identification; best advertising and marketing messages, campaigns, and/or approaches; social networking from a new or unique perspective; sharing preferences or patterns, tokenization, and more.

I also envision utilizing in whole or in part, similar cryptography schemes for commodities other than money. In particular, using similar cryptography systems or schemes for turning other things including, but not limited to, advertising and/or marketing into a sort of commodity. Then, as one scenario, this commodity (advertising for instance), could be traded and/or tracked, and perhaps allow persons impacted to remain anonymous, yet receive the full benefit of the ad (for example, the benefit of seeing a picture, then in some amount of time, the picture disappears. The user had the benefit of both seeing the picture and not having it).

This system should offer the lessor/seller/renter/provider of the product or service, the ability to make images of the related product or service, editable or not. Also, If the provider does make the images editable, they can offer special versions or limited editions. These special or limited editions can be tied to coded information and based on date and/or location, be used for contests, promotions, ads, etc.

Yet another benefit is that an ad can be loaded into the application residing on the portable device (e.g., phone, tablet, etc.) at the time of payment (or sometime after) and then launched based on location or time, that the advertiser chooses for their campaign.

Another foreseen use is that when a friend or visitor visits a social media page and moves their mouse or cursor over the image, a bubble or mini receipt with product information, locations of where to buy it (both online and offline), and the pricing displayed. The visitor can choose to put the item in a basket and choose to buy it immediately online (if available online) or choose to be notified of where the product is located if they want to find it in a brick-and-mortar location. The basket can still be filled and hold the items until paid for.

Another use or benefit that can be derived from the invention is that pictures from friends that involve products or services that the friend showed on their social media page can be accessed, and/or pulled, and displayed based on either location or timing (that relates to a predetermined schedule created by the friend or the company that made, sold, leased, or even just offered the product).

Yet one more benefit is the use of portable devices including, but not limited to, cell phones, smartphones, tablets, etc. that can be instructed to talk to other similar devices belonging to friends that are in proximity to each other. This will create a sort of virtual “feeding frenzy” or clustering effect whereby products pop up or appear on the cell phone display based on each other's likes, buying history, habits, etc., and reference to each other's pictures. A little bubble can be opened to display the product image or information on a corner or side of the phone display. Of course, this is just one way to display the image and by no means the only way.

One more benefit is that the coded information can actually be used to “talk back” to the products in the offering business (store etc.). Also, envision this as a sort of reverse advertising or even like a virtual shopping assistant but based on friend's images or previous items paid for. For example, person A is walking through the mall, but person B paid for something in the mall that person A really likes or is liked. One of several scenarios can take place:
A picture of the Item that person B paid for before can be displayed for person A to see (the picture is of course either the one altered by the friend that purchased it or the original unaltered picture);
A picture of the item that person B paid for before can be displayed for person A to see, and person A can click on the picture to see what the price and availability is for the item or service (the picture is of course either the one altered by the friend that purchased it or the original unaltered picture);
A list of items that are like the item that person B paid for can be displayed either permanently or fade away for person A to see; or
The coded information can be used to solicit other businesses to alert person A (or any other person on person A's friends list) that the business has similar products or services. This automates the process of alerting interested buyers who are friends of person A (for example) who want a product or service but are not near the location. This scenario is the essence of social media because it is a friend (or a friend of a friend) that the alert is triggered by and not the end buyer themselves.

Products can be “showcased” at a physical local retailer with a camera displaying the item for television, computer, tablet, smartphone, etc. as though you're actually in that store. Then the shopper can request the code to be downloaded to the 3D printer for them to print the purchased product in the convenience of their own home or office.

Accordingly, the instant invention can be characterized as a method for associating a user's product purchase with an image of the product on a computer network social media platform, the method including some or all of the steps of: providing a web-based computer application; providing a user email address to the application; assigning an account to the user; delivering a user product purchase receipt from a retailer to the application; converting the receipt to text format and storing it in a database; reading the product code from the receipt; looking up the retailers' website or database to see if the product is available online, and if available online, storing the web address, image, and description of the product; sending a request to the user asking for permission to post an image of the product on a social media platform of the user, and upon receipt of permission posting the image on the social media platform; and providing the image with a hyperlink to the retailer's website so that when a third party clicks the image, the third party can be directed to the retailer's website to facilitate purchase of the product.

The step of delivering a user product purchase receipt from a retailer to the application may include sending the receipt to a common email address for the retailer, or sending the receipt to the user and associating the receipt to the user. The receipt may be part of an email, or an attachment to an email. The step of reading the product code from the receipt may include OCR scanning. The method may include the step of storing a time stamp, IP address, and user ID with the retailer information for a report. The step of sending a request to the user asking for permission to post an image of the product on a social media platform of the user may include providing the user with options for the image to be used. The method may further include the step of enabling a third party to offer a review of the product.

The instant invention may alternatively be characterized as a system including one or more computers for associating a user's product purchase with an image of the product on a computer network social media platform, the system some or all of: a web-based computer application; a user email address provided to the application; an account assigned to the user; a user product purchase receipt delivered from a retailer to the application, converted to text format and stored in a database; a product code read from the receipt; generation of a query to the retailers' website or database to see if the product is available online, and if available online, storage of the web address, image, and description of the product; generation of a request to the user asking for permission to post an image of the product on a social media platform of the user, and upon receipt of permission posting the image on the social media platform; and a hyperlink from the image to the retailer's website so that when a third party clicks the image, the third party can be directed to the retailer's website to facilitate purchase of the product.

IoT lens (A hybrid approach using: AI; image storage, recognition, and cataloging; and AR and VR to recognize nearly anything and then give the user the ability to choose what to do with the item in their active mobile camera (mobile device camera is open and display is actively showing camera view). This allows the user to control how one or more inanimate or animate objects “interact”. This can then be used to allow Bluetooth® or Wi-Fi-enabled devices to perform certain functions when an object is being viewed. Another big function of this will allow the user to point and shop—it can recognize the item in the camera frame and then open our store and direct the user to the retailer that sells the item. Which retailer or seller of the item will be determined by criteria the user establishes). The technologies used in Google Street View to allow the user to feel as if they are viewing the street by phone or the phone's camera can be incorporated.

Blockchain Checkout: A complete self-checkout solution that will not be fooled to cheat the retailer it is being used in. It will use full product image recognition along with barcode scanning and geo-location to ensure the price and any specials is accurate. This can be used with an IoT lens and PAID.

Custom Eyes: Combining Stake and advertising with IoT lens and 3D Printing to get anything customized and integrated with a Bluetooth® or Near Field RFID chip so customized products can do much more.

Build-ER: Do-it-yourself mini apps that anyone can build for their business in the WeChat-like platform. The business decides what it needs, and it can use the disclosed platform and build a custom application. A user can simply answer a few questions and then be guided through a modular step-by-step process as they build it out.

CeX for retail products: Imagine tracking prices of anything and locking onto that product's (asset's) pricing with an algorithm. This should work with geo-location technology to help reduce or eliminate market manipulation.

This can then be used to categorize individual items rather than companies. Instead of tracking the companies that make products, disclosed platforms can track the products (assets) individually.

In certain implementations, the products or assets can be tokenized. How the assets can be tokenized will depend on the asset. This is due to any of several things, such as type of product/asset, the value of the product/asset, where the product/asset exists (location and if the location is fixed or portable/mobile, quantity or scarcity of the product/asset, normal volatility of the product/asset in pre-existing markets, and so on. AI could be a good application for assisting in tokenizing assets. AI could also make the process easier and smoother.

In one aspect, disclosed is a platform for inexpensive customizable retail solutions. Offering a customizable but extremely inexpensive yet valuable system that will allow retailers such as restaurants, hotels, and other service companies to build POS systems, menus, food ordering, seating, reservation solutions, and more.

In certain implementations, the disclosed platform can also include social and media groups. Examples of such groups include features in Facebook®, Instagram®, WhatsApp®, Twitter®, Linkedin®, Snapchat®, Reddit®, Pinterest®, YouTube®, TikTok®, and more.

People on a user's list of this platform can have their position identified when another person on the same list is in the same place. This could be date-dependent or time-limited. In other words, if a user goes to location A and someone on a list was at the same place before the user, the disclosed feature will show the person where the user is, now, plus show the user date and time they were there. There is also a feature that allows a user to point their mobile device camera at someone and automatically show what that person posted. Another feature is a sort of podcast that tells you about the place you are in when you are visiting some city or landmark, etc.

Blue-File—An application that allows people to share files via Bluetooth® or Wi-Fi. There is a geo-fence option where a user can leave their file(s) (actually upload to Cloud®) at a specific location, then anyone who has this application, when they are in the location (at any time, not necessarily when the other person who uploaded their file is still there), can download the file(s). This can be used as an added level of security.

RealTour—A real estate application can be provided with a feature that allows two people who are looking to rent or buy a property together, to search and agree on a property or properties. When both match (or like) a property, the application lets both persons know they agree. Then, through the feature, a booking can be made to view/visit the property.

Meta Print—This can be related to the Metaverse (using any goggles, from Meta's to Apple's and anyone else), and one can see something in the Metaverse they want. Now a user can have it, instantly. 3D printers can be provided with goggles, or, buying a 3D printer at a discount after getting the goggles. To help accelerate adoption, companies should help subsidize 3D printer adoption by offering some 3D printable products for free.

VR goggles and the Metaverse are not the only way people can enjoy 3D printed products and the association of the 3D printed product to the VR experience. AR and mobile devices will provide a similar connection between the AR experience and printing 3D-printed products.

This has also brought us to the next logical step in the evolution of product delivery—Manufacturing the product right inside our home.

Now we can order what we want, and then watch it manufactured right before our eyes. This is today's version of 3D printing, and more . . . the evolution of next-generation printers that can build the products we want or need whether through 3D printing only or a combination of 3D printing and mold making, or yet some other process or combination of processes and/or technology(ies).

3D printing is still relatively new. However instead of the owner or user of the 3D printer creating a file that becomes the part, a component of something to be prototyped, etc. to be printed in 3D, companies of any size can sell files of products to be downloaded to the user's printer to be “3D printed”, or in effect, manufactured instantly, in their home. What is more, is that we should do for all businesses that use the invention, what Apple did for the entertainment industry. I will create something like iTunes, but instead of groups/albums/songs, I will create a catalog of industries/companies/product types/products and the price for the file that ultimately gets downloaded to make the product.

Like a color or black and white printer checking to make sure there is sufficient ink to print the job before the print job is started, the ability to know if there is sufficient material to 3D print/manufacture/produce needs to be performed before charging for the product since a product might start to be produced but not finished therefore charging for a product that is less than whole.

Yet one more consideration to factor is the different materials to print with besides resins and other polymers. To offer a larger variety of products means the ability to print or cast with metals if possible.

Since the printer has become a factory, another enormous benefit is that some products can be customized before our eyes as they are made. We can choose slight variations that make the product more to our liking. This is not possible in the way products are made today (at least not in scale). Of course, the huge benefit to companies selling their products via downloadable files for the printer is that they will not have to pay the cost of materials to make the products they sell. The benefit to the customer is faster than next-day delivery—Instant delivery!

The future of this will unfold something like the following:
Initially offered and used by early adopters (businesses and customers). AI, AI Avatars, and AI Avatar models will play a role in speeding up adoption;
The price of products will be less for customers as an incentive for customers to use and to gain faster traction and shorten ramp-up time (adoption on a large scale). Companies can also afford to reduce the price of products since the cost to build is nothing for the company;
Ramp-up stage . . . more businesses join, more people buy printers, and more people buy products using 3D printers;
Companies start to reverse and spin the benefits to their (the company's) advantage and start to charge a convenience fee or at the least, charge full price. This of course makes the platform ultra profitable for these companies.

The platform provides a system for the files to be sold/licensed/leased for download or use to 3D print/manufacture/produce the product; The sharing of know how to enables almost any company to operate more efficiently, deliver better service to its customers, save money on materials, and more via the revolutionary use and vision of 3D printing (or any other similar process that accomplishes the same through a 3D physical item creating technology that can be reasonably maintained in a home (house, apartment, etc.); Provide a central, one-stop marketplace for companies to offer their products (via downloadable or shareable files). This is the app similar to iTunes®, also called iProduct; and A 3D printer that can print in many different materials will of course be in a person's home (or office too). An app is loaded onto the phone of the person that owns or leases the printer. They can then shop via the app on their phone, select the product, part, or other item, and pay to have it “printed” or produced by the printer. The library of different products accessible by the app can grow as different companies choose to be a part of the platform. Since 3D printing technology enables customization of what is being created, tokenization of the printed asset will be offered too.

Terminal Emulation—Whether, initially, all of the above is built independent of this platform or not, all of the applications above will ultimately run on this platform. This needs to run an In-App Browser.

Based on the success of WeChat in China and the Far East, but not in the West, a GPS (location) based version of WeChat can be provided that works as a single “super app” in countries where WeChat is successful but splits up into individual apps when in the US or countries where a super app does not work. Then, based on location, assimilate back into a super app.

Hollywood AI—With the right licensing structure, the disclosed platform can offer Hollywood films and films from outside of Hollywood, the chance to re-license their movie via the disclosed platform by using AI to replace certain actors and actresses with Avatars of the viewer's choosing. For instance, a viewer could watch Wolf of Wall Street for the first time with all the actors and actresses in the original film. Then, when the viewer watches it the second time, chooses to replace Margot Robbie with someone else from the disclosed AI Avatar solution. This can revive a dying industry—movie making—like nothing else.

Looker QVC—Selling live and online never got easier. Now, each viewer can see the product they are ready to buy presented by their very own model. While the product presented will be the same and at the same time for everyone, each viewer will see the product presented by an AI-generated model of their choosing.

A format for pictures, videos, presentations, and demonstrations of the product needs to be established. This needs to be done in such a way that the AI model can flawlessly present the product and so that it appears the product is actually with the AI model. There is the possibility that the product might need to be presented in more of a static, non-demonstrable format.

Since individual products and their prices can be tracked, the disclosed platform can provide the ability to track all a company's products. If a person knows all the products (and their prices) a company sells, then they can know the true value of a company.

The developers should design everything necessary to work with e-commerce platforms. This means incorporating the Looker QVC elements into this or at least build it so that when we go to add on or modify this platform for using Looker QVC, it is ready and easy to modify or add the Looker QVC functionality.

Infinite Domains—Through disclosed platform, it will 4× or more the available number of domains by allowing users to select domains that are already taken. This can be done by making the platform, the doorway to the web, and allowing visitors to choose the domain(s) of their choice, but on the backend, disclosed AI will generate the actual URL that will be registered with the domain registry. The domains through the disclosed portal will be categorized which is how it can offer more of the same already used domains.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for facilitating interactions with a digital avatar, the method comprising:
generating, a plurality of digital avatars for a plurality of persons, wherein the plurality of digital avatars are based on artificial intelligence, wherein each of the plurality of digital avatars is configured to mimic a personality of a respective person of the plurality of persons; and
establishing, autonomously, interactions between two digital avatars of the plurality of digital avatars and between a first person and a digital avatar of the plurality of digital avatars, the digital avatar is of a second person, wherein the first person and the second person are different.

2. The method of claim 1, wherein each of the plurality of digital avatars incorporates features comprising color schemes, textures, and lighting to generate accurate and photo-realistic avatars by a generator, the generator is machine learning based.

3. The method of claim 2, wherein the generator is trained using a training dataset of images to learn how to generate avatars that mimic real people.

4. The method of claim 3, wherein the method further comprises:
receiving by the generator, feedback for one or more avatars of the plurality of digital avatars, and
improving the performance of the generator based on the feedback.

5. The method of claim 4, wherein the training dataset of images comprises high-quality images that depict different features comprising eye shape, hair texture, and facial structure.

6. The method of claim 5, wherein the method further comprises:
generating the training dataset, wherein the training dataset is generated by:
cleaning the high-quality images,
resizing the high-quality images,
converting the high-quality images to a format readable using machine learning, and
labeling the high-quality images to help the generator learn to differentiate between the different features of the high-quality images.

7. The method of claim 6, wherein the method further comprises:
upon preparing the training dataset, selecting a machine learning model that fits requirements and data size.

8. The method of claim 7, wherein the machine learning model is based on Generative Adversarial Networks, wherein the Generative Adversarial Networks are configured to generate synthetic data that is similar to real data used in training.

9. The method of claim 8, wherein the method further comprises:
configuring hyperparameters of the machine learning model; and
training, using the machine learning model and the training dataset, the generator for generating the plurality of digital avatars.

10. The method of claim 1, wherein the step of mimicking comprises talking and expressing emotions like the respective person while communicating, and learning traits, habits, and interests of the respective person.

11. The method of claim 1, wherein the digital avatar is configured to help a person purchase goods and services and understand day-to-day life needs of the person.

12. The method of claim 1, wherein the first person interacts with the digital avatar of the second person to understand the likes and dislikes of the second person for dating in a non-judgmental environment avoiding hesitation and social rejection.

13. The method of claim 12, wherein the method further comprises:
ordering, by the digital avatar of the second person, an item from an online store, for the first person.

14. The method of claim 13, wherein the digital avatar is configured for presenting a product for sale, wherein the digital avatar is configured to mimic a look, body, voice, and personality of a person desired by a buyer for selling the product.

15. The method of claim 1, wherein the method further comprises:
receive, images and video feeds of person A and person B; and
creating virtual images and videos simulating persons A and B together in real life.

16. The method of claim 1, wherein the digital avatar of the second person is configured to synthesize voice of the second person for voice communication with the first person.

17. The method of claim 1, wherein the digital avatar is further configured to detect malicious applications on a smartphone.

18. The method of claim 1, wherein one or more of the digital avatars are configured to replace one or more actors in a feature film.

19. The method of claim 1, wherein the digital avatar is configured to assist in tokenization of an asset, wherein the assisting comprises:
suggesting terms and conditions of a smart contract based on a type of asset, estimated a value of the asset, and geo-location of the asset; and
creating a smart contract based on blockchain technology.
